(19) United States
(12) Patent Application Publication
(10) Pub. No.: US 2011/0128225 A1
(43) Pub. Date: Jun. 2, 2011

(54) Integrated computer art tool

(76) Inventors: William M. Louis, Encinitas, CA (US); Constance M. Louis, Encinitas, CA (US)

(21) Appl. No.: 12/927,903

(22) Filed: Nov. 29, 2010

Related U.S. Application Data
(60) Provisional application No. 61/283,076, filed on Nov. 27, 2009.

(51) Int. Cl. G09G 5/08

(52) U.S. Cl. 345/163

(57) ABSTRACT

The disclosed integrated computer art tool effectively combines a computer mouse and touchpad in one device that can function as either a mouse or touchpad. The device can also function in a third mode facilitated by a graphical user interface providing feedback to the user, so that both finger (fine) and arm (coarse) inputs can be made simultaneously. A retractable finger grip expands the user's finger range while securely holding the tool for arm input.

### CROSS-REFERENCE TO RELATED APPLICATIONS

This application claims the benefit of U.S. Provisional Patent Application, Ser. No. 61/283,076 titled “Integrated Computer Art Tool” and filed on Nov. 27, 2009 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to computer input devices, specifically, for hand generated input for pointing and drawing. Typical devices in common use are various types of the computer “mouse,” force sensing joystick, trackpad, or “touchpad” and graphics tablet.

2. Prior Art

Mice, touchpads and joysticks provide speedy cursor control across large displays, they are “pointing” devices, and are unsuitable for drawing or writing with any degree of fluidity and precision. Graphic tablets provide quality precision input using a special pen designed to work with the particular device, but they must be large and unwieldy to work smoothly in conjunction with displays of any reasonable size.

What is missing and sorely needed is a handy, compact input device that is at once easy to use by nearly everyone for common computer tasks and still has the ability to satisfy those users who wish to draw, paint or make other kinds of graphics (including handwriting) that involve skill and precision.

A close examination of what we do when writing and drawing reveals that there are two distinctive types of hand input: Coarse input associated with freely moving our hand about from position to position across the writing or drawing surface, and fine input associated with precise finger movements, manipulating a writing or drawing tool, such as pen or brush. We integrate these two inputs so naturally, that most of the time we don't notice what we're doing.

U.S. Pat. No. 6,674,425 B1, INTEGRATED POINTING AND DRAWING GRAPHICS SYSTEM FOR COMPUTERS solves the problem of how to accomplish the much needed integration of speed and precision to enable the use of a compact device to provide precision input over even large displays. It describes a graphics input window that appears on computer displays that allows the user to track and integrate relative input and absolute input. The input window provides the missing link.

However, for convenience and utility, the U.S. Pat. No. 6,674,425 B1 patent can be improved upon in some of the design features of the input device itself by a further integration of relative and absolute devices into a single unit not known before.

The recently introduced Apple Magic Mouse (November 2009) features multi-touch capabilities such as previously demonstrated on the popular Apple iPod and iPhone. The touch sensing capability is present over much of the upper mouse surface, using capacitive sensing. This mechanism uses the natural conductivity of the user's hands and body, sensing the location(s) where the finger(s) contact the active surface. However, the relative mouse input of the Apple Magic Mouse, as tracked by an optical sensing mechanism on the underside of the device, is not integrated with the absolute input of the touchpad-like sensing on the top of the mouse. The absolute input is used instead as a control system for activating the selection or “click” function previously activated on mice by buttons. The multi-touch capability add the ability to “scroll”. “swipe”, and “rotate”.

While it has been stated at least several places on the interne that the new Apple Magic Mouse is essentially a “touchpad on a mouse” . . . without buttons or scroll wheel, in no way does it combine or integrate these two kinds of input in a synergistic way.

Interestingly it has been the very same limited or crippled input capability of the computer mouse that has helped make it so popular with the general public. Graphic tablets intimidate most people. They are advertised as a tool for the artist to fully express their highly developed artistic skill in drawing and painting with pen and brush. Non-artists shy away from using a pen on paper to make a drawing of a person or landscape, avoiding embarrassing results.

With a large area multi-touch input surface as demonstrated on the Apple iPad (in contrast to the relatively small area input surface of the iPhone) an old problem resurfaces: accidental input surface contact with other than the intended input tool. On the iPad an artist painting a picture must hold his hand away from the iPad, only touching with the drawing finger, usually an index finger. Artists who work with slow drying paints, such as conventional artist's oil paint on canvas, must either carefully hold their hand off the canvas, so they don't smear the wet paint, or rest their painting hand on a “mahlstick,” which is a stick with a padded head on one end that is rested on a dry portion of the canvas. The other end is held in the non-painting hand to steady the wrist of the hand holding the brush.

The basic problem is that an artist doing fine detail work must stabilize their painting hand by resting it on something—the drawing surface (which can be a graphics tablet) or some other handy prop, such as the aforementioned mahlstick or for horizontal artwork, an artist's bridge, which has a raised support at both ends, so an artist can support their wrist or hand just above the painting surface.

All of this is immediately relevant to computer input, because accidental contact with the wrist by an artist drawing on an iPad will confound the single touch input required by the painting software. A solution based on the classic artist's bridge is shown in FIG. 13 of the previously cited U.S. Pat. No. 6,674,425 B1 patent. As an alternative, an iPad artist could wear an insulating glove with a cut-out index finger tip, so that they can comfortably stabilize their wrist and hand on the input surface/display, without accidental touch input.

Note that the iPod generally avoids the accidental contact problem, because it is small enough so that most people can conveniently rest their wrist on the side of the device, outside the sensing area. Likewise, the present invention avoids the accidental contact problem, also because of it's relatively small size and provision of a finger grip that provides a secure finger hold, and additional hand stabilizing.

U.S. Pat. No. 4,719,455, INTEGRATING POINTING DEVICE introduces a circular input area for fine input by the index finger—but with the finger resting on a moveable cup. Coarse or “gross” input in this device is by the thumb and middle finger gripping a force sensing diamond shape. Unlike with the present invention, the thumb and finger are widely separated, greatly restricting the index finger freedom of action. Also, the forces transmitted by the thumb and middle finger do not move the device, but simply apply horizontal pressure to it, like to a force sensing joystick. No input window is described, but the device could be used for such.

### Objects and Advantages

The objects and advantages of the present invention are:

(1) To provide an attractive, compact, handy and simple to use tool (can work either like an Apple Magic Mouse or a conventional touchpad, depending on how it is set up) that is instantly available to users unfamiliar with it's unique characteristics. Note that if functioning as a touchpad, the present invention can be hand-held, and even carried about to function as a remote—provided the range of the wireless system is sufficiently great.

(2) To provide the desired enhanced capability of a device integrating relative and absolute inputs such as described in the U.S. Pat. No. 6,674,425 B1 patent.

### DRAWINGS

### Figures

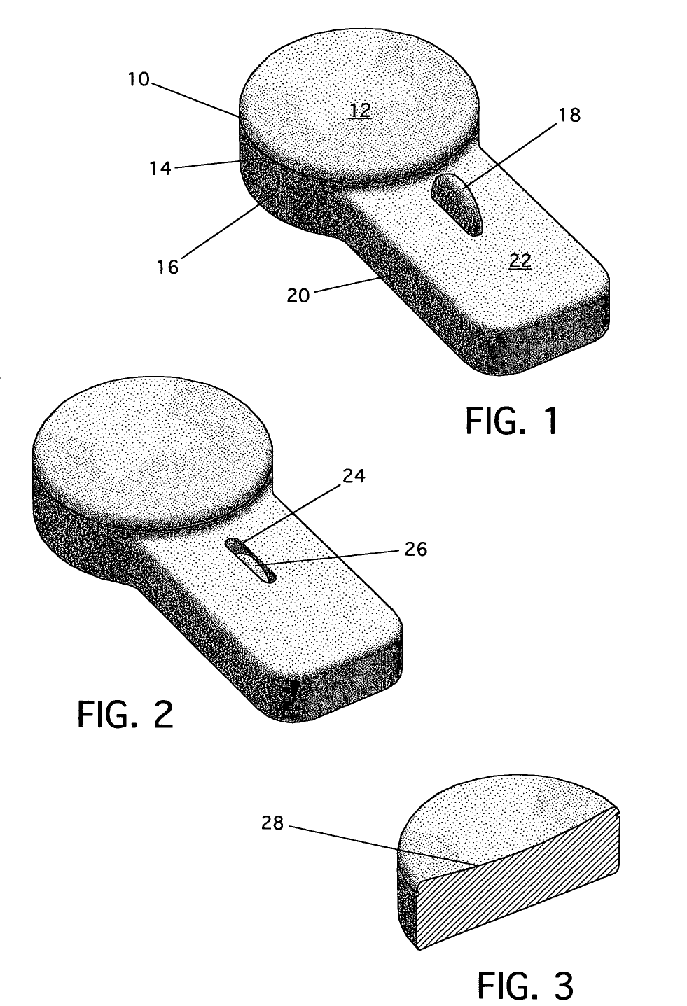

FIG. 1 is a front perspective view of one embodiment of my invention as normally seen by a user looking down onto the top of the input tool, with the finger grip in up position.

FIG. 2 is the same view as FIG. 1, of the same embodiment of my invention, but with the finger grip in down position.

FIG. 3 is a perspective sectioned view (same view parameters as FIG. 1), but limited to the touch sensing input area, revealing the curve of that area or surface.

### REFERENCE NUMERALS

10 input sensing mechanism
12 input surface or area
14 physical gap between input sensing mechanism and input housing
16 input housing
18 finger grip in up position
20 mouse or handle housing
22 mouse or handle surface
24 slot for finger grip
26 finger grip in down or retracted position
28 curve of input surface

### DESCRIPTION OF CERTAIN EMBODIMENTS OF THE INVENTION

The previously cited patent, U.S. Pat. No. 6,674,425 B1, INTEGRATED POINTING AND DRAWING GRAPHICS SYSTEM FOR COMPUTERS, describes the interface essential to the functioning of this new invention.

As shown in FIG. 1, the input surface is circular, not rectangular as illustrated in the '425 patent. However, claim 2 states: “The computer program product of claim 1, wherein the presenting steps include displaying a window having the same shape as the input surface.” (emphasis added) So it is appropriate that the window displayed on the computer display of a user of this invention is circular, representing the input area of the input surface.

The overall dimensions of the new invention are similar to those of a conventional mouse, including the Apple Magic Mouse. The input area may vary in size, depending upon intended user needs. Artists will prefer a larger area for artistic desktop use, placing less emphasis on compact size, such as is handy for a travel mouse or for use by non-artists.

The input sensing mechanism is physically isolated from the rest of the device by the physical gap between input sensing mechanism and input housing 14, allowing for independent movement, transmitting the variable finger contact pressure of the user. The pressure sensing mechanism detects only the user pressure on the input surface 12. The user may press down on the finger grip 18 as well as the mouse handle surface 22, and such pressure will not confound the pressure sensing of the input surface 12. The sensing mechanism can be the same kind evidenced by the gap employed on the Apple Magic Mouse around the side margin of that unit, so that the user can register “clicks” by pressing down on the top surface of the mouse. The pressure sensing mechanism of the Magic Mouse is sandwiched between the top surface structure and the central structure underneath it.

For artistic use, it is desirable to have the pressure sensing mechanism able to detect and utilize variable pressure, such as characteristic of FSRs or force sensing resistors (copyright by Interlink Electronics, Camarillo, Calif.). This makes it possible for an artist to do the same kind of drawing, painting or writing as that inputted on sophisticated graphic tablets with appropriate software that mimics the effects of variable pressure on paper or canvas, that cause modification of the shape of a brush or other tool. This facilitates advanced artistic expression, and enhances the desirability of the device for artists.

The size (diameter) of the input surface can range from quite small (1 inch) to large (3+inches). The input is made by touching a finger (or fingers) to the input surface, as with the Apple Magic Mouse. Most people will primarily use the index finger to do this, but other fingers can be used as desired. The edge of the input surface is readily identified by sight and feel, and is located just inside the radiused edge of the top surface.

FIG. 3 clearly shows that the curve of input surface 28 in this embodiment is concave. This relates well to the path traced by the finger moving about over the input surface. The range of curvature can be from flat to a radius of 3 inches or less.

The “mouse” type or relative input created by moving the whole device about on the desktop is conventionally detected by an optical sensor on the bottom of the device. To do this, the user must grip the mouse, usually between two or more fingers and maneuver the mouse as desired, about the two dimensions of the desktop space. When doing various artistic kinds of input, the user will input both kinds of input simultaneously, moving the whole device as well moving a finger over the input surface. Artists do this kind of thing when crosshatching and even in gross drawing motions, with detail control by the finger fine tuning the traced path. To do this, the user has to maintain a relatively secure grip on the device with side pressure by two or more fingers, while at the same time exercising freely with a finger over the input surface.

It will be appreciated that the degree of free movement or range afforded the index finger is greatly constrained or restricted the further the thumb and middle finger are separated (such as to hold onto the sides of the mouse or handle housing 20.) In order to maximize the freedom of action of a user with their finger while securely holding the tool for arm input, an unconventional solution is employed, a finger grip in up position 18.

As shown in FIG. 2, if the user chooses, they may instantly put the finger grip in down or retracted position 26. There is a spring loaded ratchet mechanism (not shown) that keeps the finger grip in position, either up or down. Simply press down, depressing the top of the grip slightly below the mouse or handle surface 22, into the slot for finger grip 24, then release pressure and the finger grip stays down. To get the finger grip in up position 18, press down again on the finger grip, again depressing it slightly below the handle surface, and it will pop up, forced by the spring into the full “up” position.

Most users will grasp the finger grip between thumb and middle finger. This allows a relatively wide range of positions for the user to hold their hand, being able to rock it forward and back and even from side to their comfort in moving a finger over the input surface. The finger grip or hold for grasping may be of a different shape or location than shown, to suit individual needs and desires.

It may at first seem somewhat clumsy to use a relatively “fat” fingertip to trace the drawing path, instead of a fine tipped pen or brush. But since the finger is not covering or partially hiding from the user's view a portion of the display surface, blocking the artist seeing the immediate work they are doing on the work surface (such as with a standard graphics tablet that is the display also) it should soon become apparent that the finger provides a refined input tool when both position and pressure are accurately input.

There are four main elements that differentiate the present invention from the Apple Magic Mouse:

(1) The unique graphical user interface employing an input window representing the input surface.

(2) The shape and position of the touch sensing surface: It is circular, negatively curved (or flat) instead of positively curved, and clearly defined with an obvious circular lip at its outer boundary, obviously separate from the handle portion of the device.

(3) The capability to isolate input pressure on the touch sensing surface only.

(4) The handy finger grip that allows wide range of finger movement on the input surface while easily moving the device about over the desktop surface on which it rests.

What is claimed is:

1. A computer mouse-like input device, with a clearly distinct, both visually and tactually, finger position and finger pressure sensing input area atop the case assembly, with finger input data from said input area input separately from the mouse-like input generated by moving the case of said device on a surface.

2. The input device of claim 1. further including an accessory means whereby the case can be movably positioned on said surface by the user, and at the same time, the user maintaining minimal separation of thumb and middle finger of the inputting hand while movably positioning the tip of the index finger of said hand on said graphics input area.

3. The input device of claim 1. further including a finger grip whereby the case can be movably positioned on said surface by the user, and at the same time the user movably positioning the tip of the index finger of said hand on said graphics input area.
